(19) United States
(12) Patent Application Publication
(10) Pub. No.: US 2024/0278805 A1
(43) Pub. Date: Aug. 22, 2024

(54) VEHICLE SAFETY SYSTEM IMPLEMENTING DYNAMIC SEVERITY AND CONTROLLABILITY DETERMINATIONS

(71) Applicant: Mercedes-Benz Group AG, Stuttgart (DE)

(72) Inventor: Sneha Sudhir Shetiya, Sunnyvale, CA (US)

(21) Appl. No.: 18/112,974

(22) Filed: Feb. 22, 2023

(51) Int. Cl. B60W 60/00; B60W 10/18; B60W 10/20; B60W 30/02; B60W 30/09; B60W 30/12; B60W 30/14; B60W 50/02; B60W 50/14

(52) U.S. Cl. CPC B60W 60/0015; B60W 10/18; B60W 10/20; B60W 30/02; B60W 30/09; B60W 30/12; B60W 30/14; B60W 50/0205; B60W 50/14; B60W 2050/0215; B60W 2420/403; B60W 2420/408; B60W 2420/54; B60W 2540/30; B60W 2552/00; B60W 2554/4029; B60W 2554/408; B60W 2555/20

(57) ABSTRACT

A vehicle computing system can receive sensor data from a sensor system of the vehicle. The system can dynamically determine, based on the sensor data, a severity percentage and a controllability percentage for each of a plurality of vehicle safety systems of the vehicle. Based on the severity percentage and the controllability percentage for a particular vehicle safety system of the plurality of vehicle safety systems, the vehicle computing system can dynamically determine whether a triggering condition for the particular vehicle safety system is met, and in response to determining that the triggering condition for the particular vehicle safety system is met, the vehicle computing system can implement a mitigation measure corresponding to the particular vehicle safety system.

### BACKGROUND

An advanced driver assistance system (ADAS) of a vehicle utilizes sensor information to automatically perform driver assist functions, such as collision warning, blind spot monitoring, adaptive cruise control, emergency braking, automatic parking, automated lane centering and lane following, and the like. Each safety system of the vehicle can perform mitigation measures or otherwise intervene with the driver's operation of the vehicle based on a set of triggering conditions.

### SUMMARY

Systems and methods are described herein for implementing dynamic severity and controllability determinations for the safety systems of a vehicle. In various examples, an on-board computing system of the vehicle can receive sensor data from a sensor system of the vehicle, and dynamically determine, based on the sensor data, a severity percentage and a controllability percentage for each of a plurality of vehicle safety systems of the vehicle. Based on the severity percentage and the controllability percentage for a particular vehicle safety system the vehicle, the computing system can dynamically determine whether a triggering condition for the particular vehicle safety system is met. In response to determining that the triggering condition for the particular vehicle safety system is met, the computing system can implement a mitigation measure corresponding to the particular vehicle safety system.

In certain implementations, the computing system can implement the mitigation measure corresponding to the particular vehicle safety system by automatically operating at least one of a braking system, a steering system, an acceleration system of the vehicle, signaling and/or other auxiliary system, and the like. In various aspects, the severity percentage and the controllability percentages calculated by the computing system can correspond to automotive safety integrity levels (ASILs), which are comprised in a risk classification scheme defined by the International Organization for Standardization (ISO). In further aspects, the mitigation measure of the particular vehicle safety system can correspond to a safety of intended functionality (SOTIF) measure, where SOTIF is defined as the absence of unreasonable risk due to hazards resulting from functional insufficiencies of the intended functionality or by reasonably foreseeable misuse by persons.

According to examples described herein, the computing system can be included as a component of an advanced driver assistance system (ADAS) of the vehicle. In variations, the computing system can be included as a component of an autonomous vehicle control system that autonomously operates the vehicle along a travel route. In either case, the sensor system of the vehicle can include a plurality of the following: (i) one or more image sensors, (ii) one or more LIDAR sensors, (iii) one or more radar sensors, or (iv) one or more ultrasonic sensors. Furthermore, the plurality of vehicle safety systems of the vehicle can include a plurality of: a brake assist system, a forward collision warning system, an automatic emergency braking system, a pedestrian detection system, an adaptive cruise control system, a blind spot warning system, an active lane steering assistance system, a rear cross-traffic alert system, a lane departure warning system, a lane-keeping assistance system, an active head restraint system, a backup camera system, a parking assistance system, an airbag system, a seat-beat locking system, a traction control system, an electronic stability control system, a collision intervention system.

In various examples, each vehicle safety system can correspond to a set of triggering conditions that cause the vehicle safety system to impose mitigation measures. In certain examples, the triggering condition(s) for a particular vehicle safety system can correspond to one of a plurality of hazardous events classified for implementing the particular vehicle safety system. As an example, a triggering condition for traditional anti-lock braking system (ABS) corresponds to the detection of tire slippage under braking, and the mitigation measures correspond to the automated control of the braking system (e.g., automatically performing threshold and/or cadence braking). In more sophisticated and modern applications, mitigation measures involving tire slippage as a triggering condition can comprise the automated control of front-to-rear brake bias, electronic brakeforce distribution, traction control, and/or electronic stability control. Numerous other triggering conditions for the various vehicle safety systems are contemplate, with specific examples described below.

In certain implementations the dynamically determined severity percentage and controllability percentage for each vehicle safety system of the plurality of vehicle safety systems can fluctuate based on a plurality of dynamic factors. These factors can include, for example, weather conditions, road infrastructure, driver behavior, a behavior of one or more other proximate vehicles, or a current driving scenario. In further examples, the dynamic factors can further include known planning algorithm limitations, known insufficiencies of sensor measurement data for machine learning, an operational design domain (ODD) of the vehicle, a mechanical disturbance of one or more sensors, a dirty or occluded sensor, electromagnetic interference of one or more sensors, acoustic disturbance of one or more sensors, glare in one or more sensors, accuracy and range of the sensor system, or performance impact of one or more sensors due to durability, wear, or aging.

As an example scenario, snowy conditions on a single-laned, winding mountain road can result in an icy underlying surface and occluded vehicle sensors, which can significantly increase the probability of a vehicular accident, and can pose increased risk of injury or death. As provided herein, the on-board computing system can perform the dynamic hazard analysis and risk assessment techniques described throughout the present disclosure based on the weather conditions, driving scenario, and the driver's driving behavior to determine, for each vehicle safety system, a severity percentage and a controllability percentage, where the severity percentage corresponds to the severity of injuries a hazardous event is likely to cause, and the controllability percentage corresponds to the relative likelihood that the driver of the vehicle will not be able to act to prevent the potential injuries as calculated by the severity percentage.

Thus, in the example of the snowy, icy conditions on the mountain road, the computing system may calculate a relatively high percentage for both severity and controllability for various safety systems of the vehicle at any given time (e.g., the emergency braking, anti-lock braking, traction control, lane-keeping assist, electronic stability control, collision intervention, and/or speed control systems). As such, mitigation interventions for each vehicle safety system can be performed when combined threshold values for the severity percentage and controllability percentage are met or exceeded, which can result in several safety system interventions as the driver operates the vehicle in such driving conditions.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system for implementing vehicle safety systems of a vehicle, according to examples described herein;

FIG. 2 is a block diagram illustrating an example vehicle computing system including specialized modules for implementing vehicle safety systems, according to examples described herein;

FIG. 3 illustrates example severity and controllability thresholds for implementing a particular vehicle safety system, according to examples described herein; and

FIGS. 4 and 5 are flow charts describing example methods of implementing vehicle safety systems for a vehicle, according to examples described herein.

### DETAILED DESCRIPTION

Electric and electronic (E/E) components of a vehicle can be included in safety systems that rely on sensing the external and/or internal vehicle environment to build situational awareness. The intended functionality and the implementation of these E/E components for a particular safety system can cause hazardous behavior, despite these E/E components being relatively free from faults addressed in the ISO 26262 series. Certain examples of this potentially hazardous behavior include, for example, the inability of the safety system to correctly perceive the environment, the lack of robustness of the safety system's function or algorithm (e.g., with respect to sensor input variations), heuristics used for sensor fusion, the diversity of environmental conditions, or unexpected behavior of the safety system due to the decision-making algorithm and/or divergent human expectations. The “safety of intended functionality” (SOTIF) corresponds to the absence of unreasonable risk due to a hazard caused by functional insufficiencies. This includes the insufficiencies of specification of the intended functionality of a safety system at the vehicle level, as well as the insufficiencies of specification or performance insufficiencies in the implementation of E/E components in the safety system. Accordingly, SOTIF mitigation measures correspond to the implementation of a particular safety system when the combination of a detected vehicular hazard (e.g., a failed component, tire slippage, etc.) and the present driving scenario (e.g., rainy conditions, dense traffic, high speed, etc.) generally create a risk of injury or loss of life and the controllability of the vehicle or safety system by the driver is not likely to prevent such injury or loss of life.

Measures to eliminate hazards or reduce risk are implemented in various phases of a vehicle safety system, including the specification and design phase, the verification and validation phase, and the operational phase of the system. In particular, (i) the modification of vehicle functionality and/or of sensor performance requirements driven by identified system insufficiencies or by hazardous scenarios in the development phase, (ii) in-loop testing of a safety system in selected SOTIF related scenarios (e.g., simulation of potential triggering conditions), and (iii) long-term vehicle testing, track testing, simulation testing, and field monitoring of real-world SOTIF incidences are all examples of such measures to eliminate hazards or reduce risk when addressing the SOTIF of a particular safety system. As provided herein, each potential hazard event is assessed in terms of severity of possible injuries within the context how much of the time a vehicle is exposed to the possibility of the hazard happening, as well as the relative likelihood that a typical driver can control the vehicle to prevent the injury.

Automotive safety integrity level (ASIL) is a risk classification scheme defined by ISO 26262 (the functional safety for road vehicles standard), and is typically established for the E/E components of the vehicle by performing a risk analysis of potential hazards, which involves determining respective levels of severity (i.e., the severity of injuries the hazard can be expected to cause; classified between S0 (no injuries) and S3 (life-threatening injuries)), exposure (i.e., the relative expected frequency of the operational conditions in which the injury can occur; classified between E0 (incredibly unlikely) and E4 (high probability of injury under most operating conditions)), and controllability (i.e., the relative likelihood that the driver can act to prevent the injury; classified between C0 (controllable in general) and C3 difficult to control or uncontrollable)) of the vehicle operating scenario. As such, the safety goal(s) for any potential hazard event includes a set of ASIL requirements.

Hazards that are identified as quality management (QM) do not dictate any safety requirements. As an illustration, these QM hazards may be any combination of low probability of exposure to the hazard, low level of severity of potential injuries resulting from the hazard, and a high level of controllability by the driver in avoiding the hazard and/or preventing injuries. Other hazard events are classified as ASIL A, ASIL B, ASIL C, or ASIL D depending on the various levels of severity, exposure, and controllability corresponding to the potential hazard. ASIL D events correspond to the highest integrity requirements (ASIL requirements) on the safety system or E/E components of the safety system, and ASIL A comprises the lowest integrity requirements. As an example, the airbags, anti-lock brakes, and power steering system of a vehicle will typically have an ASIL D grade, where the risks associated with the failure of these components (e.g., the probable severity of injury and lack of vehicle controllability to prevent those injuries) are relatively high.

As provided herein, the ASIL may refer to both risk and risk-dependent requirements, where the various combinations of severity, exposure, and controllability are quantified to form an expression of risk (e.g., an airbag system of a vehicle may have a relatively low exposure classification, but high values for severity and controllability). As provided above, the quantities for severity, exposure, and controllability for a given hazard are traditionally determined using rudimentary levels for severity (e.g., S0 through S3), exposure (e.g., E0 through E4), and controllability (e.g., C0 through C3) in the ISO 26262 series, where these values are then utilized to classify the ASIL requirements for the components of a particular safety system.

According to examples provided herein, an on-board computing system of a vehicle can dynamically determine when SOTIF mitigation conditions are met for any particular vehicle safety feature of the vehicle. In some aspects, the examples described herein may be implemented for the ISO 21448 standards for specifying measures for exposure, severity, and controllability for the safety systems of vehicles, which can provide a framework for full autonomous driving. Accordingly, embodiments described herein may be utilized for the purpose of, for example, establishing ASIL requirements for the E/E components of semi-autonomous and fully autonomous vehicles, establishing the triggering conditions for when SOTIF mitigation measures are to be taken for a particular vehicle safety system, and the dynamic determination of when to implement SOTIF measures for each vehicle safety system during operation of the vehicle. Furthermore, it is contemplated that, in addition the physical vehicle safety components and systems described herein, safety systems subjected to ASIL integrity requirements can include functions, systems, or algorithms that utilize machine learning (e.g., for autonomous driving purposes).

In various implementations, the computing system can dynamically monitor sensor data from the vehicle's sensors (e.g., cameras, LIDAR sensors, radar sensors, ultrasonic sensors, global positioning or navigation system sensors, wheel spin sensors, brake force sensors, accelerometer, barometric pressure sensor, tire pressure sensors, fuel temperature sensor, fuel pressure sensor, exhaust temperature sensor, coolant and/or water temperature sensor, mass air flow sensor, manifold pressure sensor, turbo boost sensor, air intake temperature sensor, throttle position sensor, oxygen sensor, NOX sensor, etc.). Based on monitoring the sensor data, the computing system can simultaneously (i) detect a hazardous vehicle behavior (e.g., unintended steering, tire slippage, component failure, etc.), and (ii) determine or otherwise classify a current driving scenario (e.g., dense city traffic with vulnerable road users in proximity to the vehicle, variable weather conditions, etc.).

Based on the hazardous vehicle behavior and the current driving scenario, the computing system can determine the existence of a hazardous event and perform a risk evaluation for each of the vehicle's safety systems based on the hazardous event. This risk evaluation can comprise the determination of a severity percentage and a controllability percentage for the detected hazardous event in the context of the vehicle safety system. As described above, these values correspond to the severity of injury the hazardous event is likely to cause (e.g., S=0% means no injuries; S=100% means loss of life is probable) and the amount of control the driver has over the vehicle to avoid the determined injuries (e.g., C=0% means the driver is easily able to control the vehicle to avoid injury to passengers and others; C=100% means the driver has little or no control over the vehicle). For any given vehicle safety system, if the combination of the severity percentage and the controllability percentage amount to triggering conditions (e.g., exceed respective threshold percentage values) for implementing the vehicle safety system, then the vehicle safety system implements mitigation measures accordingly.

Certain safety systems can perform variable mitigation measures, which can range from alerts (e.g., visual, auditory, or haptic alerts), minor interventions (e.g., brake assist or steer assist), to major interventions and/or avoidance maneuvering (e.g., taking over control of one or more control mechanisms, such as the steering, acceleration, or braking systems). According to examples described herein, each vehicle safety system can be associated with multiple threshold severity and controllability percentages that determine whether mitigation measures are to be implemented, and the level of mitigation measures to be implemented.

As an example, a hazardous event can involve lateral tire slippage on icy road conditions in snowy weather while the vehicle is traveling at high speed. The snow can occlude or diminish the capability of cameras or LIDAR sensors from effectively capturing the surrounding environment (e.g., to determine whether a guard rail or other entities are present). Based on this information, the computing system may determine a severity percentage of 100% and a controllability percentage of 100% for an Active Lane Steering Assistance (ALSA) system of the vehicle, which can cause the ALSA system to implement maximum mitigation measures, taking over the steering, braking, and acceleration systems of the vehicle to safely correct the lateral tire slippage and reduce the speed of the vehicle accordingly.

As provided herein, the dynamic determination of severity and controllability percentages for the vehicle safety systems of a vehicle can be utilized for advanced driver assistance systems that implement semi-autonomous driving capabilities. In further implementations, the embodiments described herein can be integrated into fully autonomous vehicles. Among other benefits, the examples described herein achieve a technical effect of performing variable SOTIF activities based on dynamic severity and controllability calculations for the individual safety functions of each vehicle safety system using real-time sensor data. Embodiments described herein further provide an improved safety framework for future autonomous vehicle operations.

As further provided herein, while the dynamic determination of severity and controllability are described in terms of percentage values, the embodiments described herein are not limited to such calculations and/or determinations. Rather, the determination of percentage values for severity and controllability are provided for illustrative purposes, and can be readily substituted for other severity and controllability determination schemes (e.g., lettered schemes, other numbered schemes, worded schemes, etc.), with safety system thresholds for implementing different levels of mitigation measures being established accordingly.

In certain implementations, the computing system can perform one or more functions described herein using a learning-based approach, such as by executing an artificial neural network (e.g., a recurrent neural network, convolutional neural network, etc.) or one or more machine-learning models to process the surrounding environment of the vehicle as well as other sensor data. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer-programs, or a computer usable carrier medium capable of carrying such a program.

### Example Computing System

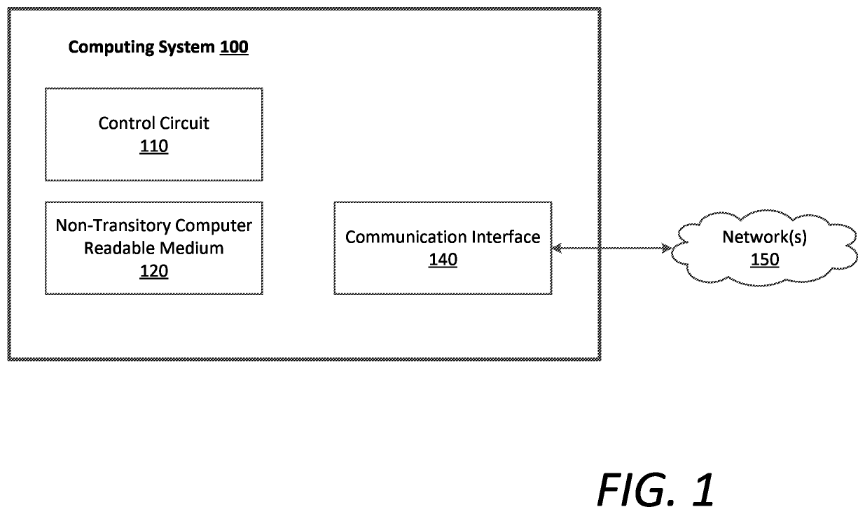

FIG. 1 is a block diagram depicting an example computing system for implementing vehicle safety systems of a vehicle, according to examples described herein. In an embodiment, the computing system 100 can include a control circuit 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 110 and/or computing system 100 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, or any other controller (the term “or” is used herein interchangeably with “and/or”). In variations, the control circuit 110 and/or computing system 100 can be included on one or more servers (e.g., backend servers).

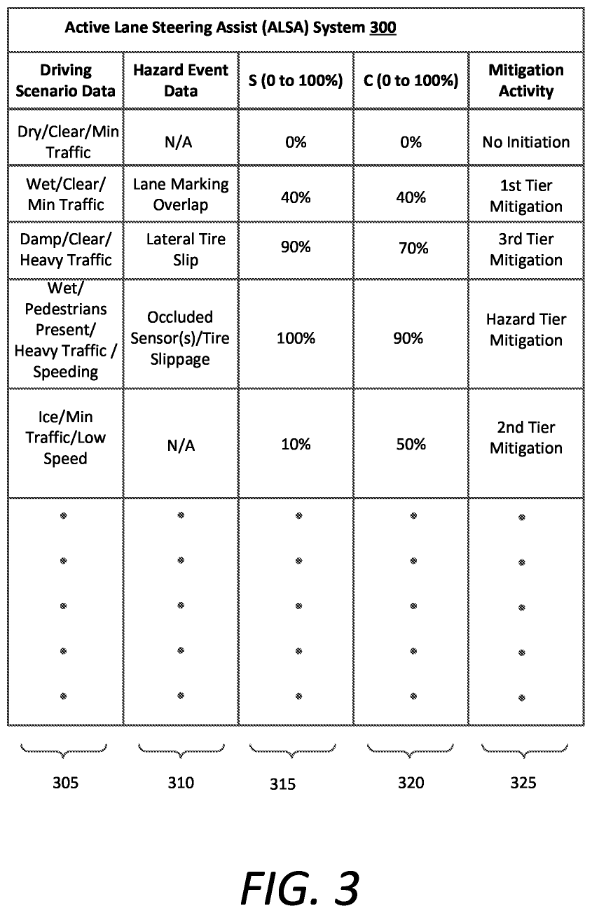

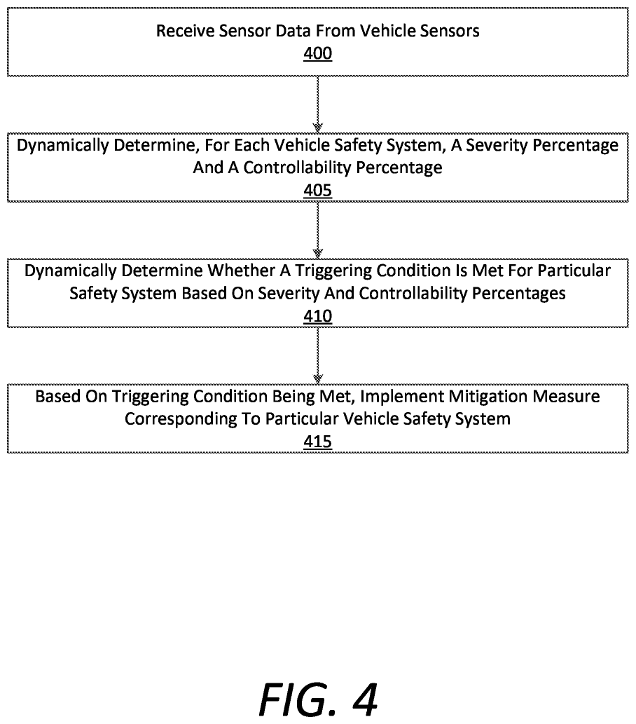

In an embodiment, the control circuit 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, e.g., a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with of FIGS. 3 and 4.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when a control circuit 110 or other hardware component is executing the modules or computer-readable instructions.

In further embodiments, the computing system 100 can include a communication interface 140 that enables communications over one or more networks 150 to transmit and receive data. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the computing system 100 can reside on an on-board vehicle computing system and can receive sensor data from the various vehicle sensors a vehicle. Based on the sensor data, the control circuit 110 can dynamically determine severity and controllability percentages for each of a plurality of vehicle safety systems of the vehicle. Based on the severity percentage and the controllability percentage for a particular vehicle safety system the vehicle, the computing system can dynamically determine whether a triggering condition for the particular vehicle safety system is met. For example, each safety system can be associated with respective severity and controllability threshold values that correspond to triggering conditions that determine when and how the safety system is to implemented. In response to determining that a triggering condition for the particular vehicle safety system is met, the control circuit 110 can implement a mitigation measure corresponding to the particular vehicle safety system.

### System Description

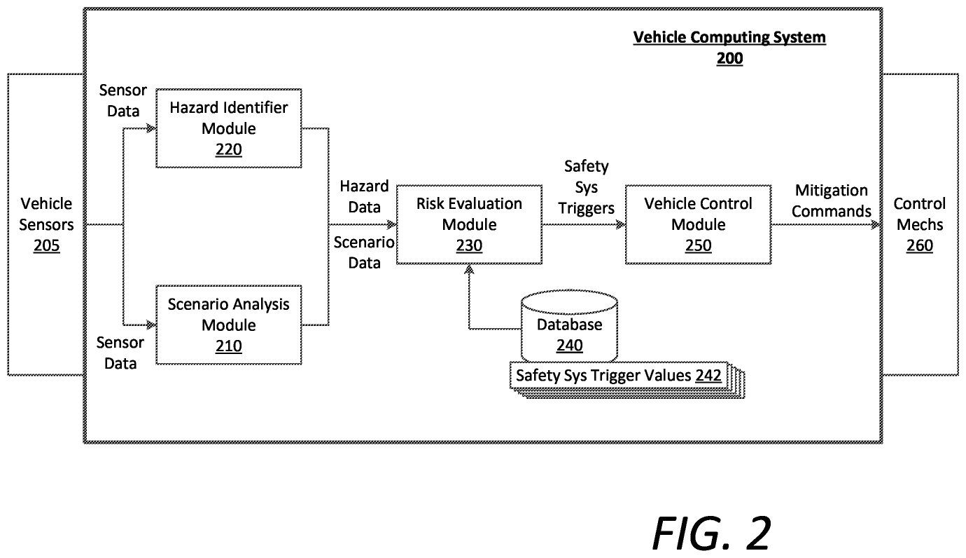

FIG. 2 is a block diagram illustrating an example vehicle computing system including specialized modules for implementing vehicle safety systems, according to examples described herein. In various implementations, the vehicle sensors 205 of the vehicle can include external monitoring sensors, such as radar sensors (e.g., for automated or emergency brake assist), LIDAR sensors and/or cameras (e.g., for environment perception and automated vehicle control), and/or ultrasonic sensors (e.g., for proximity determination). In further implementations, the vehicle sensors 205 can include internal monitoring sensors, such as any combination of global positioning or navigation system sensors, wheel spin sensors, brake force sensors, accelerometers, accelerator pedal position sensors, barometric pressure sensors, tire pressure sensors, fuel temperature sensors, fuel pressure sensors, exhaust temperature sensors, safety system sensors (e.g., indicating performance or any failures of any particular vehicle safety system), coolant and/or water temperature sensors, mass air flow sensors, manifold pressure sensors, turbo boost sensors, air intake temperature sensors, throttle position sensors, oxygen sensors, NOX sensors, etc.

As the vehicle operates, a scenario analysis module 210 of the vehicle computing system 200 can process the sensor data to determine the current driving scenario. As provided herein, the scenario analysis module 210 can process sensor data from a set of cameras and/or LIDAR sensors to generate scenario data that can indicate, for example, the current weather conditions (e.g., rain, snow, sleet, clear, sunny, ambient temperature, etc.), the road conditions (e.g., levels of wetness, dryness, ice, slush, etc.), the current road infrastructure (e.g., the number of lanes, competing lanes, windiness versus straightness of the underlying road, pavement versus gravel or dirt, concrete versus asphalt, guard rails or other barriers, lane markings, bicycle lanes, intersection details, rural versus urban driving environment, and the like), current road rules (e.g., speed limit, right-of-way information, etc.), driver behavior of the vehicle operator (e.g., whether the driver is speeding given the current road conditions, whether the driver is lane-keeping properly, etc.), the behaviors of one or more other proximate vehicles, motorcycles, bicycles, or pedestrians (e.g., an unsafe lane change, extreme braking, a jaywalking pedestrian, etc.), and other aspects of the overall driving scenario (e.g., congested traffic, the presences of vulnerable road users. etc.).

In various examples, the scenario analysis module 210 can provide the scenario data to a risk evaluation module 230 of the vehicle computing system 200 continuously or dynamically. In variations, the scenario analysis module 210 can be triggered to provide the scenario data to the risk evaluation module 230 based on a detected hazard event by a hazard identifier module 220 of the vehicle computing system 200. As provided herein, the risk evaluation module 230 can operate to determine respective levels of severity and controllability for each of a plurality of safety systems based on the scenario data, as well as hazard data provided by the hazard identifier module 220.

In various implementations, the hazard identifier module 220 can process sensor data from various vehicle sensors 205 to determine whether a hazard event occurs and the type of hazard event that occurs. For example, the hazard identifier module 220 can detect, based on the sensor data, whether the vehicle experiences unintended steering, a tire failure, tire slippage based on acceleration, lateral tire slippage, tire slippage under braking, an E/E component failure, a brake failure, a drive train failure, a power unit failure, an oil leak, a battery system failure, electric motor fault or failure, a sensor fault or failure, sensor occlusion or wear, a safety system fault or failure, and the like. When a hazard event is detected, the hazard identifier module 220 can provide hazard data corresponding to the hazard event to the risk evaluation module 230 of the vehicle computing system 200.

The combined hazard data and scenario data can provide contextual information to the risk evaluation module 230 to perform a risk assessment of the current situation. Various example scenarios are possible that are indicative of the current risks to the vehicle, driver, passengers, and external entities (e.g., pedestrians, other vehicles, bicyclists, etc.), including various combinations of weather conditions, road conditions, road infrastructure, lane marking information, intersection details, the presence and density of traffic, pedestrians, bicyclists, and the operation of the vehicle itself (e.g., sensor faults, safety system issues, tire tread level, braking effectiveness, vehicle weight, current grip levels, etc.). As provided herein, these factors can amount to the current overall risk(s) determined by the risk evaluation module 230 in terms of severity and controllability, which determine whether a particular safety system is to initiate mitigation measures (e.g., intervene with the driver's operation of the vehicle).

The risk evaluation module 230 processes the hazard data from the hazard identifier module 220 and the scenario data from the scenario analysis module 210 based on a set of safety system trigger values 242 (e.g., stored in a database 240 of the vehicle computing system 200). The set of safety system trigger values 242 can correspond to the triggering conditions for implementing each safety system of the vehicle. As provided herein, the safety system trigger values 242 can further correspond to threshold severity and controllability percentages that, when met, cause the risk evaluation module 230 to generate safety system triggers to cause the corresponding safety system to implement its mitigation measures. Further illustration of the safety system trigger values 242 for a particular safety system is provided below with respect to FIG. 3.

In various implementations, the risk evaluation module 230 performs dynamic calculations of severity and controllability percentages based on the current hazard data and the scenario data for each vehicle safety system. When the combination of the individual severity percentage and controllability percentage exceed their respective safety system trigger values 242 for implementing the safety system, the risk evaluation module 230 provides a safety system trigger corresponding to the trigger values to a vehicle control module 250 to implement the corresponding mitigation commands of the safety system. In particular, the vehicle control module 250 can automatically intervene with the driver's operation of the vehicle to implement the mitigation commands on one or more control mechanisms 260 of the vehicle. As provided herein, the control mechanisms 260 can comprise a steering system, braking system, acceleration system, and/or signaling and auxiliary system of the vehicle.

As an illustration, the emergency brake assist system of the vehicle can be associated with various severity thresholds and controllability thresholds that determine the manner in which the system is to intervene. For example, a first-tier intervention can correspond to the emergency brake assist system automatically applying the brakes gently when both the severity percentage reaches 30% and the controllability percentage reaches 30%. The conditions may be present when, for example, the driver is operating the vehicle with excess speed in rainy conditions and a slower vehicle is present within fifty meters ahead of the vehicle. As another example, a hazard-tier intervention can correspond to the emergency brake assist system applying maximum braking (e.g., with ABS) when the severity percentage reaches 70% and the controllability percentage reaches 90% (e.g., the driver is unlikely to control the vehicle to avoid the potential injuries as determined by the severity percentage). This scenario can occur when, for example, the vehicle is traveling at high speed and a pedestrian is detected within twenty-five meters ahead of the vehicle.

Numerous examples and combinations of driving scenarios, hazard events, and severity and controllability thresholds for each safety system of the vehicle are possible. It is contemplated herein that given each possible driving scenario and hazard event, a user or vehicle manufacturer can establish severity and controllability thresholds that trigger a safety system and the manner in which the safety system intervenes or otherwise implements mitigation measures (e.g., SOTIF activities). Accordingly, the embodiments described herein support the implementation of vehicle safety systems based on variable behavior and variable functionality, and can further support future safety standards for autonomous vehicle operation on public roads.

In various embodiments, the vehicle computing system 200 can be implemented to perform the actions of any number of vehicle safety systems, which can each utilize any number of E/E components and/or control mechanisms 260 to perform their respect safety functions. The implementation of each safety system is determined by the safety system trigger values 242 for the safety system, which can be stored in a database 240, other otherwise associated with each safety system. The risk evaluation module 230 processes the hazard data and scenario data outputs from the hazard identifier module 220 and the scenario analysis module 210 to dynamically determine whether the triggering conditions for any particular vehicle safety system has been met. If so, the risk evaluation module 230 can generate a set of safety system triggers that correspond to the triggering conditions so that the vehicle control module 250 can perform the corresponding mitigation measures accordingly.

It is contemplated that the functions of any of the hazard identifier module 220, scenario analysis module 210, risk evaluation module 230, or vehicle control module 250 can be included in a computing system of a human-driven vehicle, semi-autonomous vehicle, and/or fully autonomous vehicle. For human-driven vehicles, the system 200 can be implemented to manage the operations of each vehicle safety system, or a subset of the vehicle's safety systems, and can support and/or override the vehicle controls (e.g., braking, acceleration, and steering systems) operated by the driver. For autonomous vehicle implementations, the system 200 can comprise an integration of the autonomous control system that performs autonomous perception, motion planning, and vehicle control actions, or can be included as a separate, backup safety system that can intervene with the autonomous controls as if the autonomous control system were a human driver.

### Example Safety System Thresholds

FIG. 3 illustrates example severity and controllability thresholds for implementing a particular vehicle safety system, according to examples described herein. While the example shown with respect to FIG. 3 corresponds to the active lane steering assist (ALSA) system 300 of the vehicle, each vehicle safety system can be associated with similar sets of trigger values as represented by the severity percentages 315 and controllability percentages 320 as shown in FIG. 3. As provided herein, the trigger values represented by the severity percentages 315 and controllability percentages 320 can correspond to the safety system trigger values 242 as shown and described with respect to FIG. 2. As provided herein, the examples shown and described with respect to FIG. 3 are for illustrative purposes, and are not intended to limit any embodiments of the present disclosure.

Referring to FIG. 3, a group of engineers and/or designers of a vehicle safety system may develop, simulate, test, and refine the vehicle safety system in order to determine the variable mitigation activities 325 (e.g., tiered mitigation measures) for the safety system. As shown in the example of FIG. 3, the safety system can comprise the ALSA system 300 of a vehicle. Based on the development and refinement of the ALSA system 300, a set of ALSA system thresholds (e.g., represented by the severity column 315 and controllability column 320) can be established that determine the triggering conditions and the manner in which the ALSA system 300 is to be implemented. As shown in FIG. 3, the mitigation activities 325 (e.g., SOTIF activities) of the ALSA system 300 can include multiple tiers of intervention and/or mitigation. For example, a first-tier mitigation can correspond to the ALSA system performing a minor lane-following intervention when the vehicle overlaps a lane marking boundary. As another example, a second-tier mitigation can correspond to corrective steering measures when severity percentage is relatively low, but controllability percentage is relatively high (e.g., icy conditions in low speed). Third-tier and hazard-tier mitigation measures can be implemented by the ALSA system 300 when more extreme conditions exists with respect to severity and controllability, and can involve intervening or taking over input controls of the vehicle from the driver to, for example, avoid collisions.

As provided herein, numerous scenarios with regard to driving scenario data 305 and hazard event data 310 may exist at any given time. Thus, the columns listing driving scenario data 305 and hazard event data 310 are merely provided for illustration, and the risk evaluation module 230 described with respect to FIG. 2 performs the risk assessment-involving severity percentage and controllability percentage calculations-dynamically based on the current scenario data and hazard data. When the severity percentage and the controllability percentage meet or exceed the respective thresholds shown in the severity column 315 and the controllability column 320, the ALSA system 300 can implement the corresponding mitigation measures accordingly.

As further provided herein, the framework illustrated in FIG. 3 may be implemented for each vehicle safety system, with respective threshold values for severity and controllability established accordingly. Therefore, when the risk evaluation module 230 of FIG. 2 determines that a particular severity percentage and controllability percentage corresponding to the safety system meet or exceed the respective thresholds, the risk evaluation module 230 causes the safety system to perform the mitigation measures in accordance with the mitigation activity column 325. As such, each of the vehicle safety systems are continuously deployable based on the calculations of the risk evaluation module 230. Furthermore, while the functions of the ALSA system 300 described in FIG. 3 are variable and involve multiple tiers (e.g., multiple actions and levels of intervention), certain safety systems may be binary (e.g., on or off) or involve more or less variable actions and/or tiers of intervention.

### Methodology

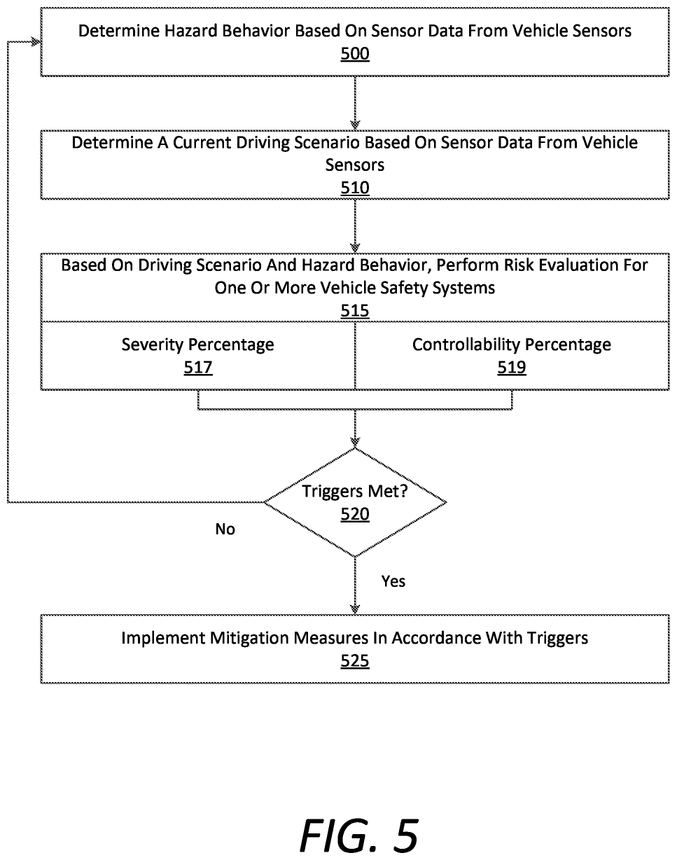

FIGS. 4 and 5 are flow charts describing example methods of implementing vehicle safety systems for a vehicle, according to examples described herein. In the below descriptions of FIGS. 4 and 5, reference may be made to reference characters representing various features as shown and described with respect to FIGS. 1 through 3. Furthermore, the processes described in connection with FIGS. 4 and 5 may be performed by an example computing system 200 as described with respect to FIG. 2. Further still, certain steps described with respect to the flow charts of FIGS. 4 and 5 may be performed prior to, in conjunction with, or subsequent to any other step, and need not be performed in the respective sequences shown.

Referring to FIG. 4, at block 400, the vehicle computing system 200 can receive sensor data from the vehicle sensors 205 of the vehicle. As described above, the vehicle sensors 205 can include external monitoring sensors, such as cameras, LIDAR sensors, radar sensors, proximity sensors, as global positioning or navigation system sensors, barometric pressure sensors, and the like. In further examples, the vehicle sensors 205 can include vehicle monitoring sensors, such, wheel spin sensors, brake force sensors, accelerometers, tire pressure sensors, fuel temperature sensors, fuel pressure sensors, exhaust temperature sensors, coolant and/or water temperature sensors, mass air flow sensors, manifold pressure sensors, turbo boost sensors, air intake temperature sensors, throttle position sensors, oxygen sensors, NOX sensors, etc.

At block 405, the vehicle computing system 200 can dynamically determine, for each vehicle safety system of the vehicle, a severity percentage or value and a controllability percentage or value. As provided herein, the severity percentage can correspond to the potential severity of injuries given the current driving scenario and/or hazard event determined by the computing system 200. Based on the severity and controllability percentages, at block 410, the vehicle computing system 200 dynamically determines whether a triggering condition is met for a particular safety system. As described throughout, the triggering condition can correspond to respective severity and controllability thresholds that are predetermined for the particular safety system. At block 415, based on the triggering condition being met, the vehicle computing system 200 can implement the mitigation measure corresponding to the particular vehicle safety system accordingly.

FIG. 5 is a flow chart describing another method of implementing the safety systems of a vehicle, according to examples described herein. Referring to FIG. 5, at block 500, the vehicle computing system 200 can determine hazard behavior based on sensor data from the vehicle sensors 205. As provided herein, the hazard behavior can correspond to one or more of the driving behavior of the driver or the vehicle behavior given the current conditions (e.g., speeding, tire slippage, steering anomalies, braking or acceleration anomalies, etc.). At block 510, the vehicle computing system 200 can further determine a current driving scenario based on the sensor data from the vehicle sensors 205. As provided herein, the current driving scenario can comprise the current weather conditions, road conditions, road infrastructure, weather pedestrians are present, traffic conditions, traffic density, and the like.

Based on the driving scenario and the hazard behavior, at block 515, the vehicle computing system 200 can perform a risk evaluation for one or more vehicle safety systems of the vehicle. As described above, the risk evaluation can comprise a determination of a severity percentage, at block 517, and the determination of a controllability percentage, at block 519. In various examples, the severity percentage and the controllability percentage correspond to automotive safety integrity levels (ASILs), in which various combinations of severity, exposure, and controllability are quantified to form an expression of risk. At decision block 520, the vehicle computing system 200 determines whether any triggering conditions are met for any of the vehicle safety systems. If not, then the computing system 200 does not implement mitigation measures for the particular safety system, and continues to monitor potential hazard events and/or driving conditions.

However, if the triggering conditions for a safety system are met, then the vehicle computing system 200 implements one or more mitigation measures in accordance with the triggering conditions, at block 525. As provided herein, the computing system 200 implement the mitigation measure(s) corresponding to the particular vehicle safety system by automatically operating at least one of a braking system, a steering system, or an acceleration system of the vehicle. As further provided herein, the mitigation measure(s) of the particular vehicle safety system can correspond to a safety of intended functionality (SOTIF) measure of the particular vehicle safety system.

It is contemplated that the vehicle computing system 200 can comprise a component of an advanced driver assistance system (ADAS) of the vehicle, or can by included as a component of an autonomous vehicle control system that autonomously operates the vehicle along a travel route. Furthermore, the vehicle safety system can comprise any safety system, such as a brake assist system, an active lane steering assist system, a forward collision warning system, an automatic emergency braking system, a pedestrian detection and/or avoidance system, an adaptive cruise control system, a blind spot warning system, a rear cross-traffic alert system, a lane departure warning system, a lane-keeping assistance system, an active head restraint system, a backup camera system, a parking assistance system, an airbag system, a seat-beat locking system, a traction control system, an electronic stability control system, a collision intervention system, and the like.

It is further contemplated that the triggering conditions for any of the foregoing safety systems can be predetermined, and the functionality of the safety systems may be variable based on the triggering conditions. As such, the hazardous events that trigger the safety system can be predetermined and/or classified, for example, based on testing, simulation, development, and/or real-world operation of the safety system. Furthermore, the dynamically determined severity percentage and controllability percentage for each vehicle safety system of can fluctuate based on any combination of weather conditions, road infrastructure, driver behavior, a behavior of one or more other vehicles, a driving scenario, known planning algorithm limitations, known insufficiencies of sensor measurement data for machine learning, an operational design domain (ODD) of the vehicle, a mechanical disturbance of one or more sensors, a dirty or occluded sensor, electromagnetic interference of one or more sensors, acoustic disturbance of one or more sensors, glare in one or more sensors, accuracy and range of the sensor system, or performance impact of one or more sensors due to durability, wear, aging, and other hazards or driving conditions.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. A computing system for a vehicle, the computing system comprising:
one or more processors;
a memory storing instructions that, when executed by the one or more processors, cause the computing system to:
receive sensor data from a sensor system of the vehicle;
dynamically determine, based on the sensor data, a severity percentage and a controllability percentage for each of a plurality of vehicle safety systems of the vehicle;
based on the severity percentage and the controllability percentage for a particular vehicle safety system of the plurality of vehicle safety systems, dynamically determine whether a triggering condition for the particular vehicle safety system is met; and
in response to determining that the triggering condition for the particular vehicle safety system is met, implement a mitigation measure corresponding to the particular vehicle safety system.

2. The computing system of claim 1, wherein the executed instructions cause the computing system to implement the mitigation measure corresponding to the particular vehicle safety system by automatically operating at least one of a braking system, a steering system, or an acceleration system of the vehicle.

3. The computing system of claim 1, wherein the severity percentage and the controllability percentage correspond to automotive safety integrity levels (ASILs).

4. The computing system of claim 1, wherein the mitigation measure of the particular vehicle safety system corresponds to a safety of intended functionality (SOTIF) measure.

5. The computing system of claim 1, wherein the computing system is included as a component of an advanced driver assistance system (ADAS) of the vehicle.

6. The computing system of claim 1, wherein the computing system is included as a component of an autonomous vehicle control system that autonomously operates the vehicle along a travel route.

7. The computing system of claim 1, wherein the sensor system of the vehicle includes a plurality of the following: (i) one or more image sensors, (ii) one or more LIDAR sensors, (iii) one or more radar sensors, or (iv) one or more ultrasonic sensors.

8. The computing system of claim 1, wherein the plurality of vehicle safety systems include a plurality of: a brake assist system, a forward collision warning system, an automatic emergency braking system, a pedestrian detection system, an adaptive cruise control system, a blind spot warning system, a rear cross-traffic alert system, a lane departure warning system, a lane-keeping assistance system, an active head restraint system, an active lane steering assist system, a backup camera system, a parking assistance system, an airbag system, a seat-beat locking system, a traction control system, an electronic stability control system, or a collision intervention system.

9. The computing system of claim 1, wherein the triggering condition for the particular vehicle safety system corresponds to one of a plurality of hazardous events classified for implementing the particular vehicle safety system.

10. The computing system of claim 1, wherein the dynamically determined severity percentage and controllability percentage for each vehicle safety system of the plurality of vehicle safety systems fluctuate based on a plurality of: weather conditions, road infrastructure, driver behavior, a behavior of one or more other vehicles, a driving scenario, known planning algorithm limitations, known insufficiencies of sensor measurement data for machine learning, an operational design domain (ODD) of the vehicle, a mechanical disturbance of one or more sensors, a dirty or occluded sensor, electromagnetic interference of one or more sensors, acoustic disturbance of one or more sensors, glare in one or more sensors, accuracy and range of the sensor system, or performance impact of one or more sensors due to durability, wear, or aging.

11. A non-transitory computer readable medium storing instructions that, when executed by one or more processors of a computing system, cause the vehicle computing system to:
receive sensor data from a sensor system of the vehicle;
dynamically determine, based on the sensor data, a severity percentage and a controllability percentage for each of a plurality of vehicle safety systems of the vehicle;
based on the severity percentage and the controllability percentage for a particular vehicle safety system of the plurality of vehicle safety systems, dynamically determine whether a triggering condition for the particular vehicle safety system is met; and
in response to determining that the triggering condition for the particular vehicle safety system is met, implement a mitigation measure corresponding to the particular vehicle safety system.

12. The non-transitory computer readable medium of claim 11, wherein the executed instructions cause the computing system to implement the mitigation measure corresponding to the particular vehicle safety system by automatically operating at least one of a braking system, a steering system, or an acceleration system of the vehicle.

13. The non-transitory computer readable medium of claim 11, wherein the severity percentage and the controllability percentage correspond to automotive safety integrity levels (ASILs).

14. The non-transitory computer readable medium of claim 11, wherein the mitigation measure of the particular vehicle safety system corresponds to a safety of intended functionality (SOTIF) measure.

15. The non-transitory computer readable medium of claim 11, wherein the computing system is included as a component of an advanced driver assistance system (ADAS) of the vehicle.

16. The non-transitory computer readable medium of claim 11, wherein the computing system is included as a component of an autonomous vehicle control system that autonomously operates the vehicle along a travel route.

17. The non-transitory computer readable medium of claim 11, wherein the sensor system of the vehicle includes a plurality of the following: (i) one or more image sensors, (ii) one or more LIDAR sensors, (iii) one or more radar sensors, or (iv) one or more ultrasonic sensors.

18. The non-transitory computer readable medium of claim 11, wherein the plurality of vehicle safety systems include a plurality of: a brake assist system, a forward collision warning system, an automatic emergency braking system, a pedestrian detection system, an adaptive cruise control system, a blind spot warning system, a rear cross-traffic alert system, a lane departure warning system, a lane-keeping assistance system, an active head restraint system, an active lane steering assist system, a backup camera system, a parking assistance system, an airbag system, a seat-beat locking system, a traction control system, an electronic stability control system, or a collision intervention system.

19. The non-transitory computer readable medium of claim 11, wherein the triggering condition for the particular vehicle safety system corresponds to one of a plurality of hazardous events classified for implementing the particular vehicle safety system.

20. A computer-implemented method of operating a vehicle, the method being performed by one or more processors and comprising:
receiving sensor data from a sensor system of the vehicle;
dynamically determining, based on the sensor data, a severity percentage and a controllability percentage for each of a plurality of vehicle safety systems of the vehicle;
based on the severity percentage and the controllability percentage for a particular vehicle safety system of the plurality of vehicle safety systems, dynamically determining whether a triggering condition for the particular vehicle safety system is met; and
in response to determining that the triggering condition for the particular vehicle safety system is met, implementing a mitigation measure corresponding to the particular vehicle safety system.
